(19) United States
(12) Patent Application Publication
(10) Pub. No.: US 2026/0317057 A1
(43) Pub. Date: Oct. 15, 2026

(54) POWERING GARBAGE VEHICLES COMPONENTS WITH A COMPOUND SPLIT RING PLANETARY GEARBOX

(71) Applicant: The Heil Co., Chattanooga, TN (US)

(72) Inventor: Ethan Lee Maness, Rainsville, AL (US)

(21) Appl. No.: 19/645,949

(22) Filed: Apr. 13, 2026

Related U.S. Application Data
(60) Provisional application No. 63/789,265, filed on Apr. 15, 2025.

(51) Int. Cl. B65F 3/08; B65F 3/02

(52) U.S. Cl. CPC B65F 3/08; B65F 2003/025

(57) ABSTRACT

A refuse collection vehicle includes a vehicle chassis and a refuse body. The refuse body is physically mounted on the vehicle chassis. The refuse body has a lift assembly to reposition a customer refuse container. The lift assembly includes a mast, a grabber, and a lift drive. The lift drive couples the grabber to the mast. The lift drive vertically repositions the grabber along the mast. The lift drive includes an electric motor and a gearbox. The gearbox is driven by the electric motor. The gearbox includes a compound split ring planetary gear assembly with an input sun gear connected to the electric motor and an output ring gear rotatable to move the grabber along the mast.

### CROSS-REFERENCE TO RELATED APPLICATION

This application claims the benefit under 35 U.S.C. § 119(e) of U.S. Patent Application No. 63/789,265, entitled “Powering Garbage Vehicles Components With A Compound Split Ring Planetary Gearbox,” filed April 15, 2025, which is incorporated herein by reference in its entirety.

### TECHNICAL FIELD

This disclosure relates to the field of refuse collection vehicles.

### BACKGROUND

Refuse collection vehicles pick up quantities of refuse (e.g., garbage, waste, recyclables, and so on) for hauling to a designated area, such as a landfill, transfer station, or material recovery facility. These vehicles hold the refuse in a large refuse body which is a storage container supported on the vehicle chassis. Many refuse collection vehicles include onboard systems such as a lift arm that move customer refuse containers holding refuse to deposit the refuse into the refuse body and a packer that transfers refuse from an intake area (e.g., a hopper) of the refuse body into the storage container and compacts the refuse within the storage container. Some refuse bodies are electrically powered from the vehicle chassis. Sometimes, the electrical power is transferred into high torque mechanical motion for operation of refuse collection vehicle components such as the lift arm and the packer.

### SUMMARY

Aspects of this disclosure are directed to vehicles, systems, and techniques that facilitate refuse collection, storage, and compaction.

In one aspect, a refuse collection vehicle includes a vehicle chassis and a refuse body physically mounted on the vehicle chassis. The refuse body includes a lift assembly. The lift assembly has a mast, a grabber, and a lift drive. The lift drive couples the grabber to the mast. The lift drive vertically repositions the grabber along the mast. The lift drive includes an electric motor and a gearbox driven by the electric motor. The gearbox includes a compound split ring planetary gear assembly having an input sun gear connected to the electric motor and an output ring gear rotatable to move the grabber along the mast.

In another aspect combinable with any other aspect, the mast includes a rack and the lift drive includes a sprocket engaged to the rack. The compound split ring planetary gear assembly drives the sprocket to vertically reposition the lift drive along the rack relative to the mast.

In another aspect combinable with any other aspect, the compound split ring planetary gear includes an input section and an output section. The input section has a first input ring gear, the input sun gear, and a first set of input planet gears. The first input ring gear is fixed in position within a housing of the lift drive. The input sun gear is a first input sun gear driven by the electric motor. The first set of input planet gears couple the first input sun gear to the first input ring gear. The output section includes the output ring gear, a first set of output planet gears, and a first output sun gear. The output ring gear is a first output ring gear. The first output ring gear is coupled to the sprocket. The first output ring gear is rotatable relative to the first input ring gear. The first set of output planet gears are coupled to and extend from the first set of input planet gears. The first set of output planet gears are coupled to the first output ring gear. The first set of output planet gears drive the first output ring gear. The first output sun gear is positioned inward from the first set of output planet gears.

In another aspect combinable with any other aspect, the first output sun gear is an idler.

In another aspect combinable with any other aspect, rotation of the electric motor rotates the first input sun gear, the first input sun gear rotates the first set of input planet gears around the first input ring gear moving the first set of output planet gears about the first output sun gear, and responsive to moving the first set of output planet gears, rotating the first output ring gear relative to the first input ring gear.

In another aspect combinable with any other aspect, the first input sun gear is defined by a first input sun gear diameter and the first output sun gear is defined by a first output sun gear diameter, the first input sun gear diameter greater than the first output sun gear diameter.

In another aspect combinable with any other aspect, the first set of input planet gears are each defined by a first input planet gear diameter and the first set of output planet gears are each defined by a first output planet gear diameter. The first input planet gear diameter is less than the first output planet gear diameter.

In another aspect combinable with any other aspect, a gear ratio between the first input ring gear and the first output ring gear is approximately 25.5.

In another aspect combinable with any other aspect, the compound split ring planetary gear includes a set of shafts. Each shaft of the set of shafts couples an associated input planet gears of the first set of input planet gears to an associated output planet gear of the first set of output planet gears.

In another aspect combinable with any other aspect, the electric motor is a first electric motor, the compound split ring planetary gear assembly is a first compound split ring planetary gear assembly, and the sprocket is a first sprocket. The lift drive includes a second electric motor and a second compound split ring planetary gear assembly. The second compound split ring planetary gear assembly is coupled between the second electric motor and the mast. A second output ring gear of the second compound split ring planetary gear assembly is coupled to a second sprocket engaged to the rack.

In another aspect combinable with any other aspect, the first sprocket and the second sprocket are fixed together to rotate in unison.

In another aspect combinable with any other aspect, the sprocket includes the output ring gear.

In another aspect combinable with any other aspect, teeth of the output ring gear extend inward from the output ring gear and teeth of the sprocket extend outward from an outer surface of the output ring gear.

In another aspect combinable with any other aspect, the lift drive includes a flanged hub coupling the output ring gear to the sprocket.

In another aspect combinable with any other aspect, the output ring gear includes a series of projections extending outward from the output ring gear to vertically reposition the grabber along the mast.

In another aspect, a refuse collection vehicle includes a vehicle chassis and a refuse body. The refuse body is physically mounted on the vehicle chassis. The refuse body includes a lift assembly having a mast with a chain, a grabber, and a lift drive coupling the grabber to the mast. The lift drive vertically repositions the grabber along the mast. The lift drive includes an electric motor and a gearbox driven by the electric motor. The gearbox has a compound split ring planetary gear assembly and a drum. The compound split ring planetary gear assembly has an input sun gear connected to the electric motor and an output ring gear rotatable to move the grabber along the mast. The drum includes a series of projections extending outward from the drum to engage the chain. The drum is driven by the compound split ring planetary gear assembly to vertically reposition the grabber along the mast.

In another aspect, a refuse collection vehicle includes a vehicle chassis, a refuse body physically mounted on the vehicle chassis, and a grabber. The grabber has grabber arms, an electric motor, and a gearbox. The gearbox couples the electric motor to the grabber arms. The gearbox has a compound split ring planetary gear assembly. The compound split ring planetary gear assembly includes an input sun gear connected and driven by the electric motor and an output ring gear rotatable to articulate the grabber arms between an open position and a closed position to engage a customer refuse container.

In another aspect, a refuse collection vehicle includes a vehicle chassis, a refuse body physically mounted on the vehicle chassis, and a front end loader. The front end loader is rotatably coupled to the vehicle chassis. The front end loader repositions a customer refuse container to reposition the customer refuse container relative to the refuse body. The front end loader incudes a pair of forks, an electric motor, and a gearbox. The pair of forks engage the customer refuse container. The gearbox couples the electric motor to the pair of forks. The gearbox includes a compound split ring planetary gear assembly. The compound split ring planetary gear assembly includes an input sun gear connected and driven by the electric motor and an output ring gear rotatable to reposition the pair of forks relative to the refuse body to deposit contents of the customer refuse container in the refuse body.

In another aspect, a refuse collection vehicle includes a vehicle chassis, a refuse body physically mounted on the vehicle chassis, a packer to reposition customer refuse within the refuse body, and a drive assembly to operate the packer. The drive assembly includes an electric motor and a gearbox coupling the electric motor to the packer. The gearbox has a compound split ring planetary gear assembly. The compound split ring planetary gear assembly includes an input sun gear connected and driven by the electric motor and an output ring gear rotatable to operate the packer to reposition customer refuse within the refuse body.

In another aspect combinable with any other aspect, the output ring gear is rotatable to rotate the packer to reposition customer refuse within the refuse body.

In another aspect combinable with any other aspect, the output ring gear is rotatable to translate a position of the packer within the refuse body to reposition customer refuse within the refuse body.

In another aspect, a twin motor drive includes two drive motors and a dual input compound split ring planetary gear assembly. The dual input compound split ring planetary gear assembly is disposed between and connecting the two drive motors. The dual input compound split ring planetary gear assembly includes a first planetary geartrain, a second planetary geartrain, and a third planetary geartrain. The first planetary geartrain has a first sun gear coupled to be driven by a first of the two drive motors. The second planetary geartrain has a second sun gear coupled to be driven by a second of the two drive motors. The third planetary geartrain connects the first and second planetary geartrains by planet gears of the third planetary geartrain fixed to rotate with associated planet gears of both the first and second planetary geartrains, the third planetary geartrain having an output ring gear. The first sun gear to the output ring gear forms a drivetrain for the first of the two drive motors. The second sun gear to the output ring gear forms a drivetrain for the second of the two drive motors such that the two drive motors may be simultaneously operated to cooperatively drive the output ring gear.

In another aspect combinable with any other aspect, the drivetrain for the first of the two drive motors and the drivetrain for the second of the two drive motors define numerically identical gear ratios.

In another aspect combinable with any other aspect, the two drive motors each have a rotor. The rotors of the two drive motors can be concentric.

Particular implementations of the subject matter described in this specification can be implemented to realize one or more material advantages. For example, the compound split ring planetary gearbox described here may be smaller in volume, achieve higher torque, and to be more electrically efficient than other gearboxes. These compound split ring planetary gearboxes can eliminate the need for an axle to transmit torque from the motor/gearbox to the sprocket. Additionally, compound split ring planetary gearboxes can be used within a drum for to move along a rope or move a rope or other flexible tether for a linear actuator.

Furthermore, this compound split ring planetary gearbox can be configured to fit inside a pulley assembly for a drive system. Using the compound split ring planetary gearbox with the pulley system nested inside the pulley, and not taking up any additional space, can allow for the reduction in size of the motor, a boom, and the surrounding structures while maintaining equal torque levels with improved efficiency and weight savings. Additionally, a holding torque of refuse collection vehicle implement drive systems can be increased. In some implementations, the number and size of component brake systems may be reduced or they may even be eliminated.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a side-loading refuse collection vehicle featuring various aspects of the present disclosure.

FIG. 2 is a top view of the vehicle of FIG. 1 with a portion of the refuse collecting body hidden to show the internal storage volume of the storage container.

FIG. 3 shows a lift drive for repositioning a grabber along a lift of the refuse collection vehicle of FIG. 1.

FIG. 4 is an exploded view of the lift drive of FIG. 3.

FIG. 5 is a cross-section of the lift drive of FIG. 3.

FIG. 6 is a perspective view of the lift drive of FIG. 3.

FIG. 7 is a side view of the lift drive of FIG. 3.

FIG. 8 is a side view of a planet gear of the lift drive of FIG. 3.

FIG. 9 is a side view of an input ring gear and an output ring gear of the lift drive of FIG. 3.

FIG. 10 is a perspective view of a pulley lift drive for repositioning a grabber along a mast of the refuse collection vehicle of FIG. 1.

FIG. 11 is a perspective view of a grabber for engaging a custom refuse container for refuse collection vehicle of FIG. 1.

FIG. 12 is a perspective view of a front end loader for a front-loading refuse collection vehicle.

Like reference symbols in the various drawings indicate like elements.

### DETAILED DESCRIPTION

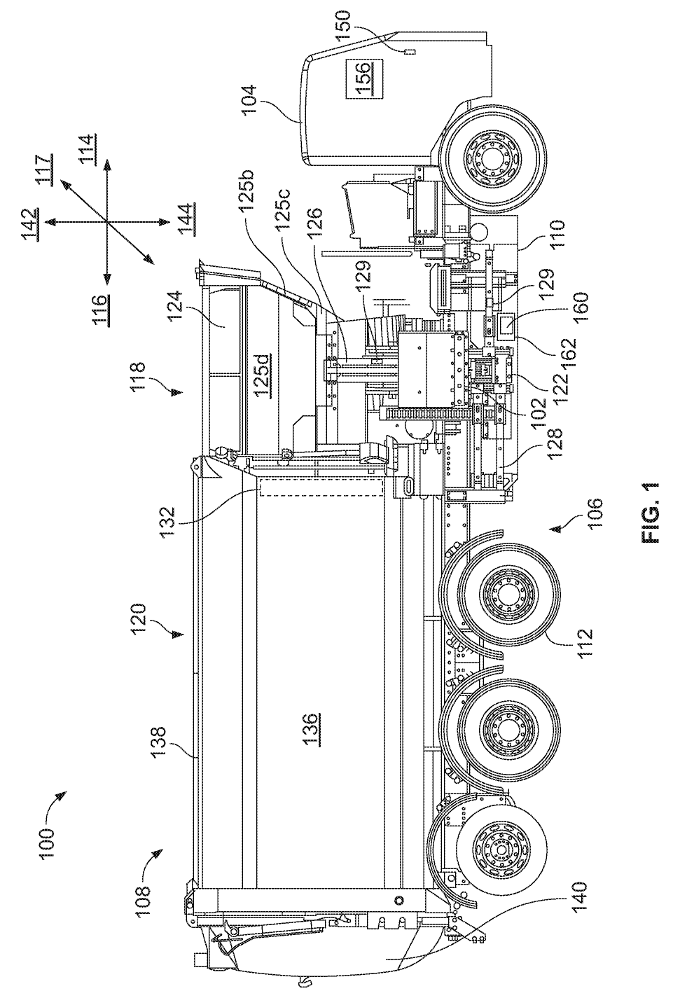

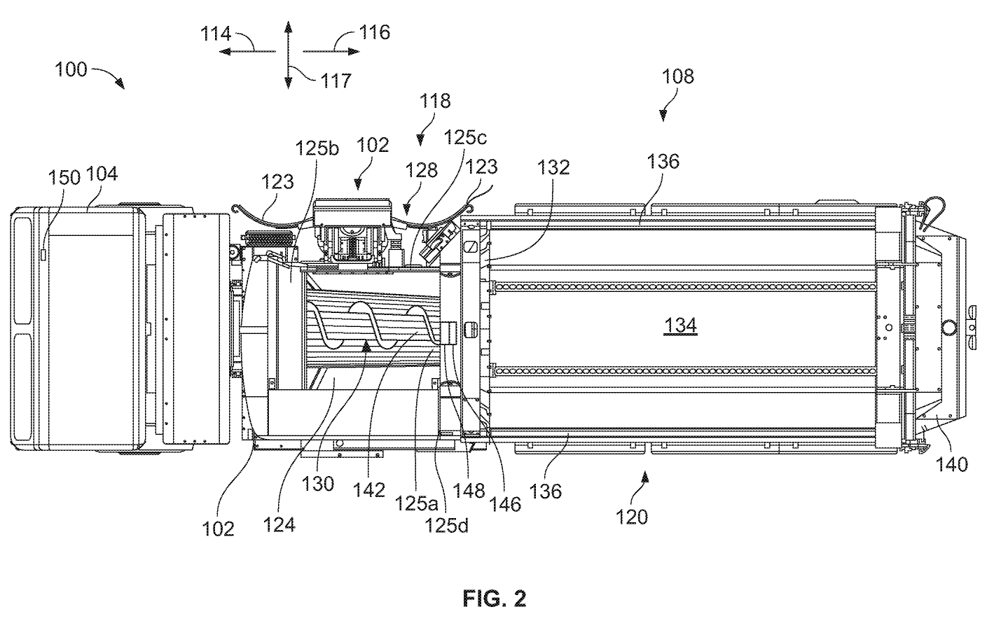

FIGS. 1-2 depict a refuse collection vehicle 100 for collecting, packing, and transporting refuse (e.g., garbage, waste, recyclables, and so on) to a designated area such as a landfill, a transfer station, or a material recovery facility. The refuse collection vehicle 100 has a lift assembly for repositioning a grabber that moves the customer refuse container to dump the customer refuse into the refuse body. The lift assembly has an electric motor and a gearbox. The gearbox is driven by the electric motor. The gearbox has a compound split ring planetary gear assembly with an input sun gear connected to the electric motor and an output ring gear that rotates to move the grabber up and down.

The refuse collection vehicle 100 can be called a garbage collection vehicle or garbage truck. The refuse collection vehicle 100 includes a cab 104, a chassis 106, and a refuse collecting body 108. The cab 104 includes a compartment for a driver of refuse collection vehicle 100. The compartment is equipped with controls that enable the driver to operate various elements of the chassis 106 and the body 108 and one or more displays that enable the driver to monitor such elements. The chassis 106 includes a power train 110 (e.g., an electric power train or a hybrid power train such as a fuel cell). The power train 110, which includes a prime mover and a drivetrain (transmission), converts and transfers motive power to the wheels 112 that move the vehicle 100 on a road surface along a forward direction of travel 114 and a rearward direction of travel 116. The direction across the vehicle 100 and orthogonal to the forward/rearward directions is a transverse direction 117. The direction away from a surface of the Earth on which the vehicle 100 travels is an upward direction 142. The direction toward the surface of the Earth on which the vehicle 100 travels is a downward direction 144. The refuse collection vehicle 100 is a side-loader in which the customer refuse is loaded into the refuse collecting body 108 from the side of the vehicle 100.

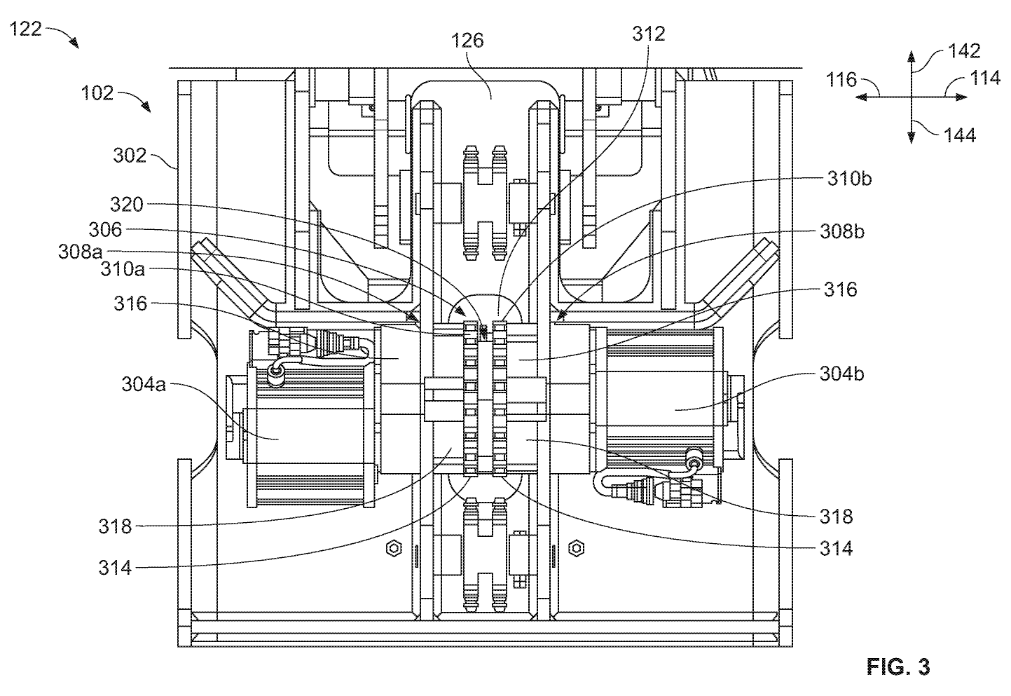

The refuse collecting body 108 includes an intake system 118, a storage container 120, a packer 130, an ejector 132, and a tailgate 140. The intake system 118 includes a lift 122 and a hopper 124. As discussed below, one or more components of the intake system 118, the storage container 120, the packer 130, the ejector 132, and the tailgate 140 are controlled by an onboard computing system including a controller 150 (i.e., a body controller 150) shown in FIGS. 3-5. The packer 130 repositions customer refuse that has been deposited within the hopper 124 into the storage container 120 in the rearward direction 116.

The lift 122 is operable to transfer the contents of residential refuse containers into the storage container 120 via the hopper 124. In this example, the lift 122 includes a side-loading arm assembly including a reach (not shown), a mast 126, a grabber 128 with grabber arms 123, and a lift drive 102 coupling the grabber 128 to the mast 126. The lift drive 102 repositions the grabber 128 along the mast 126. During use, when vehicle 100 pulls up to a residential refuse container, the lift 122 performs a dump-cycle “service event” that includes: (i) moving the grabber 128 in the transverse direction away from the vehicle and toward the container via the reach; (ii) engaging (e.g., grasping) the container with the grabber 128; (iii) moving the grabber 128 with the container back toward the vehicle via the reach; (iv) raising the grabber 128 by actuating the lift drive 102 and the container vertically along the mast 126 in the upward direction; and (v) dumping the contents of the container into the hopper 124. A set of one or more lift sensors 129 monitor operation of the lift 122 during the dump cycle. Then, the lift drive 102 returns the grabber 128 down along the mast 126 vertically back to the original starting position.

The storage container 120 provides a refuse storage volume defined (at least in part) by a floor 134, lateral side walls 136, and a cover 138. The ejector 132 features a movable panel that provides a front wall of the storage volume, separating the storage container 120 from the hopper 124. The tailgate 140 provides the storage volume’s rear wall.

The hopper 124 is located forward of the storage container 120. The hopper 124 provides a refuse intake volume defined (at least in part) by a floor 125a, a front wall 125b facing cab 104, a loading-side wall 125c facing lift 122, an opposite port-side wall 125d, and the movable panel of ejector 132. When lift 122 performs a dump cycle, the grabber 128 and the refuse container it holds are raised and at least partially upended over the loading-side wall 125c to deposit the container’s contents into the intake volume of hopper 124.

In one exemplary (but non-limiting) use-case, the vehicle 100 traverses a refuse collection route including numerous (e.g., hundreds) service stops to pick up residential refuse containers, dump waste into the hopper 124, transfer waste from the hopper 124 into the storage container 120, and compact the waste within the storage container 120. After completing all or part of a collection route, vehicle 100 travels to a designated area and ejects the waste from the storage container 120 using the ejector 132. To eject a load of waste, tailgate 140 pivots from a closed position (as shown in FIGS. 1-2) to an open position, and the panel of ejector 132 moves rearward, pushing the load through the tailgate opening (an “eject event”). A set of one or more ejector sensors 133 monitor operation of ejector 132 during such an ejection event.

These lifting, dumping, and ejecting operations performed by the refuse collecting body 108 are powered by an electrical power system and controlled by the body controller 150. The body controller 150 controls operation on components, systems, and subsystems of the chassis 106. The power train 110 can include the electrical power system when the refuse collection vehicle is an electrically powered vehicle. The electrical power system can include an electrical storage device to generate and/or store an electrical charge and supply electrical power to the components of the chassis 106 and the refuse collecting body 108. In this example, the electrical storage device is a battery. In other implementations, the electrical storage device 160 can be a fuel cell, capacitor, super-capacitor, or a regeneration system. The electrical power system can include a high voltage direct current supply system 162. In this implementation, a typical high voltage range is between 400-850 volts DC (VDC). In other implementations, the maximum voltage can be 1000 VDC, 1200 VDC, or even 1500 VDC. The electrical power system may have any suitable high voltage range. The electrical power system supplies the high voltage electrical power from the electrical storage device 160 to the refuse body 108.

Referring to FIG. 3, the lift drive 102 moves the grabber 128 (not shown in FIG. 3) along the mast 126 vertically in the upward direction 142 and the downward direction 144 to reposition the customer refuse container relative to the refuse collecting body 108 to deposit the customer refuse held in the customer refuse container into the refuse collecting body 108 and return the grabber 128 to engage another customer refuse container. The lift drive 102 has a housing 302, two electric motors 304a, 304b, a gearbox 306 with two compound split ring planetary gear assemblies 308a, 308b, and a pair of sprockets 310a, 310b. The two electric motors 304a, 304b, the gearbox 306 with two compound split ring planetary gear assemblies 308a, 308b, and the pair of sprockets 310a, 310b are contained within the housing 302. The electric motor 304a rotates the compound split ring planetary gear assembly 308a, and in response, the compound split ring planetary gear assembly 308a rotates the sprocket 310a. The electric motor 304b rotates the compound split ring planetary gear assembly 308b, and in response, the compound split ring planetary gear assembly 308b rotates the sprocket 310b. The sprockets 310a, 310b are engaged to a rack 312 which extends along the mast 126. The teeth 314 of the sprockets 310a, 310b couple to the teeth of the rack 312 to climb up and down the mast 126.

The electric motors 304a, 304b are electrically coupled to the electrical power system of the vehicle 100. The electric motors 304a, 304b receive electricity from the electrical power system and operate the associated compound split ring planetary gear assembly 308a, 308b. The electric motors 304a, 304b are physically mounted to the housing 302. The electric motors 304a, 304b are mounted on opposing sides of the compound split ring planetary gear assemblies 308a, 308b to drive the compound split ring planetary gear assemblies 308a, 308b.

The electric motors 304a, 304b are oriented within the housing 302. The electrical motors 304a, 304b are configured to rotate in the same rotational direction to operate the sprocket 320 with two rows of teeth 310a, 310b in the same direction. The electric motors 304a, 304b rotate the sprocket 320 in either the clockwise direction or the counterclockwise direction. This arrangement can decrease the overall size of the lift drive 102, while also increasing the operating torque and holding torque of the lift drive 102. The electric motors 304a, 304b each have a rotor. The rotors of the two electric motors 304a, 304b are concentric.

The compound split ring planetary gear assemblies 308a, 308b each have an input section 316 and an output section 318. The input section 316 and the output section 318 are coupled together. The output section 318 rotates relative to the input section 316. The input section 316 is mounted in the housing 302. The input section 316 is coupled to the associated electric motor 304a, 304b. The output section 318 is coupled to the sprocket 320.

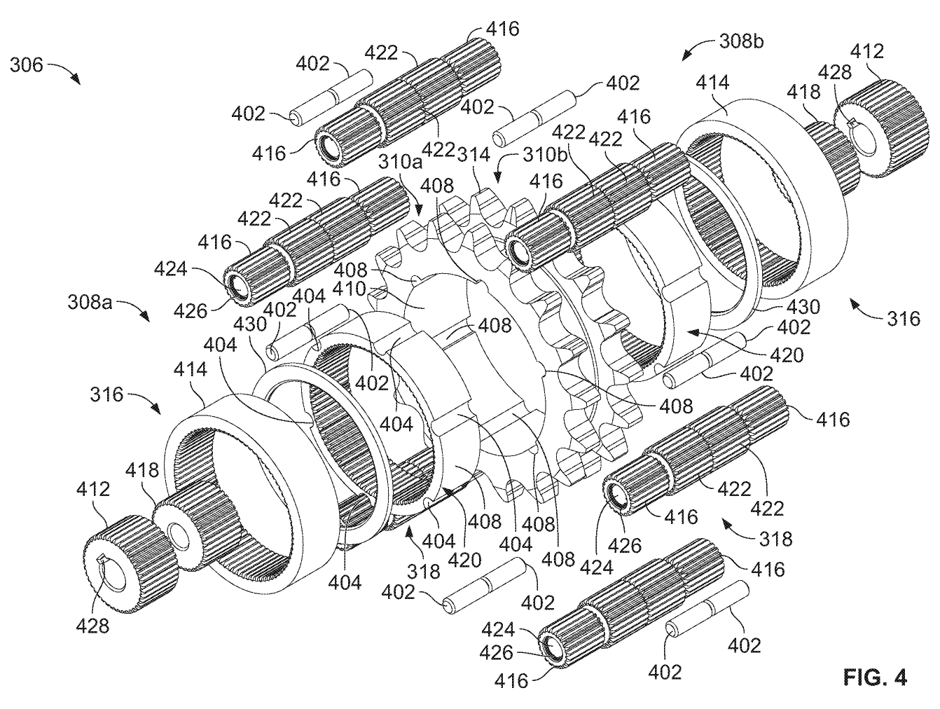

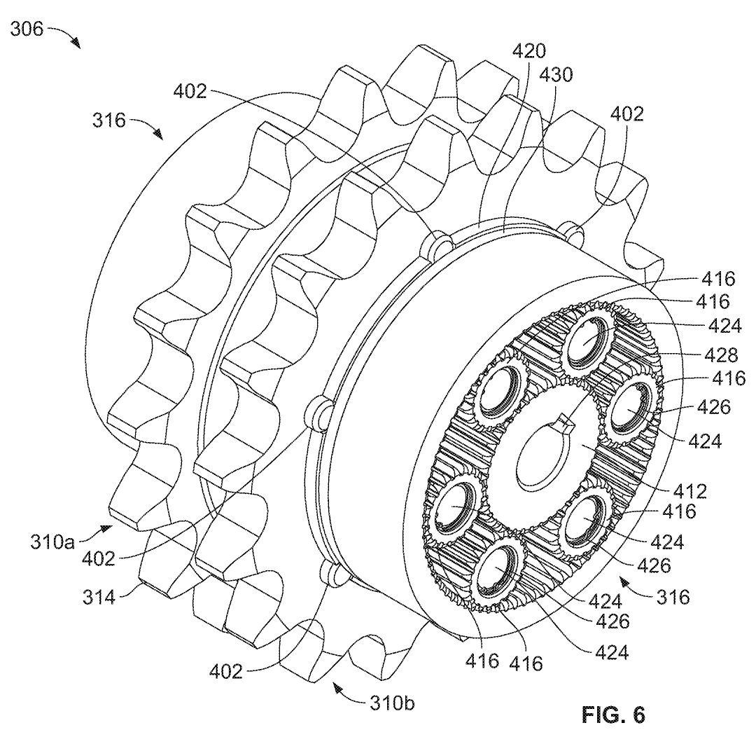

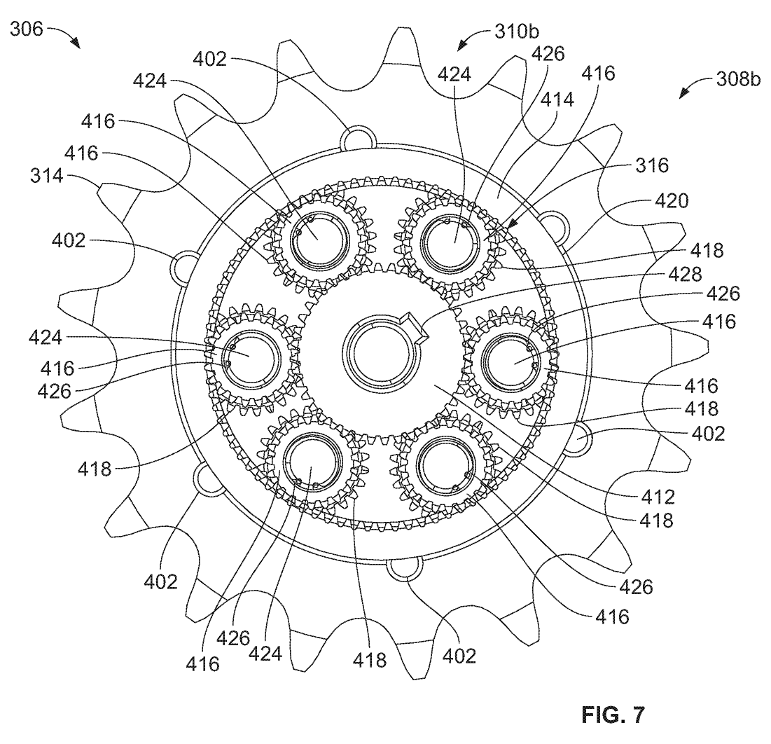

Referring to FIGS. 4-8, the gearbox 306 is shown in an exploded view to illustrate the individual components of the compound split ring planetary gear assemblies 308a, 308b. The gearbox 306 includes the two compound split ring planetary gear assemblies 308a, 308b coupled to the sprocket 320 which is a solid unitary body having two sets of teeth 310a, 310b. In other implementations, the sprocket 320 can have a single large row of teeth.

The output sections 318 are coupled to the sprocket 320 by pins 402 extending through retaining channels 404 and 406. The output sections 318 rest inside the sprocket 320. The retaining channel 404 is positioned on an outer surface 408 of the associated output section 318. The retaining channel 404 extends from the outer surface 408 of the output section 318 into the output section 318. The retaining channel 406 is positioned on an inner surface 410 of the sprocket 320. The retaining channel 406 extends from the inner surface 410 of the sprocket 320. The pins 402 rest in the retaining channels 404, 406 to couple the associated output sections 318 to the sprocket 320.

In this embodiment, twelve retaining pins 402 are used. Six retaining pins 402 couple each of the associated output sections 318 to the sprocket 320. In other implementations, any suitable number of retaining pins 402 may be used. In other implementation, any suitable fastener or means of coupling the output sections 318 to the sprocket 320 may be used. In other embodiments, a portion of the output section 318 may be integrally formed with the sprocket 320.

The input section 316 has an input sun gear 412, an input ring gear 414, and a set of input planet gears 416. The output section 318 has an output sun gear 418, an output ring gear 420, and a set of output planet gears 422.

Turning to the input section 316, the input sun gear 412 is connected to the associated electric motor 304a, 304b. The input sun gear 412 has a keyway 428 to couple to a key seat on the drive shaft of the electric motor 304a, 304b by a key. The electric motors 304a, 304b rotate the associated input sun gear 412 in the clockwise or counterclockwise direction about a longitudinal axis of the gearbox 306.

The input ring gear 414 is mechanically mounted to the housing 302. The input ring gear 414 is fixed in position. The input rig gear 414 does not rotate.

The set of input planet gears 416 are disposed between and engaged to the input sun gear 412 and the input ring gear 414. The set of input planet gears 416 couple the input sun gear 412 to the input ring gear 414. The input planet gears 416 are rotatable in a clockwise or counterclockwise direction about their own center axis in the opposite direction of rotation of the associated input sun gear 412 to translate position across the input ring gear 414 in the same direction of rotation as the associated input sun gear 412. Each of the input planet gear 416 drives the associated output planet gear 422.

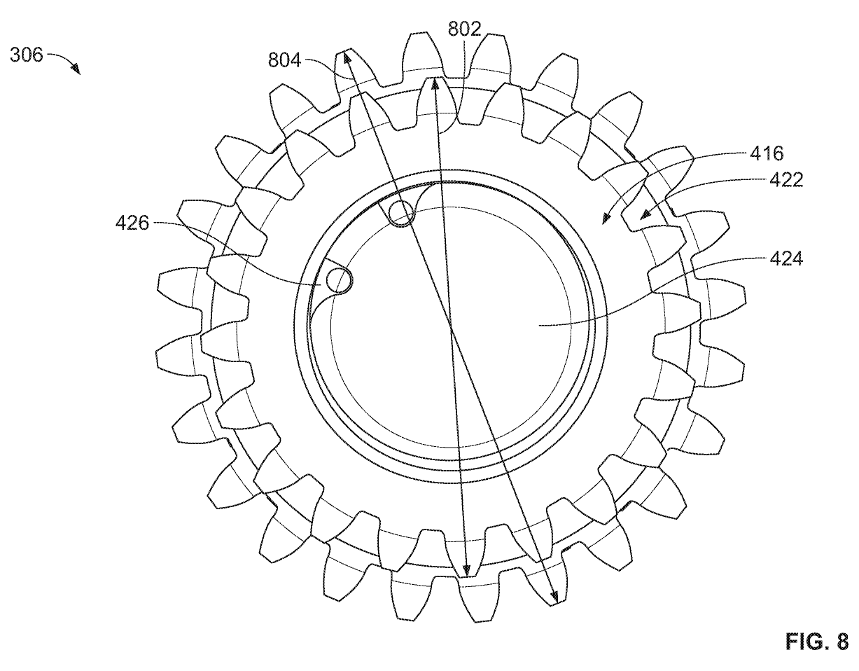

Each of the input planet gears 416 and an associated one of the output planet gears 422 are portions of a single unitary body and spaced apart by a groove. As described in reference to FIG. 8, the output planet gears 422 and the input planet gears 416 have a different overall diameter and number of teeth. The associated input planet gear 416 and output planet gear 422 are mounted on a shaft 424 and held on the shaft 424 by a retaining ring 426. Two combined input planet gear 416 and output planet gear 422 bodies are positioned on each shaft 424 and held on the associated shaft by two retaining rings 426 with one retaining ring 426 on each end of the shaft 424. The output planet gears 422 are closer together than the input planet gears 416. The input planet gears 416 are on the ends of the shaft 424. The output planet gears 422 are mounted inward from the input planet gears 416 and in contact with one another.

The output section 318 includes the output sun gear 418, the output ring gear 420, and the output planet gears 422. The output section 318 transfers the rotational force from the input section 316 to the sprocket 320 at a different force based on a gear ratio (a different number of teeth and diameter) between the input section 316 and the output section 318.

Similarly, each of the output planet gears 422 is combined with one of the input planet gears 416 into a single unitary body. The single unitary body has a groove that spaces the associated output planet gear 422 away from the associated input planet gear 416. As described in reference to FIG. 8, the output planet gears 422 and the input planet gears 416 have a different overall diameter and number of teeth. The output planet gear 422 and the associated input planet gear 416 are mounted on the shaft 424 and held on the shaft 424 by the retaining ring 426. The output planet gear 422 and the associated input planet gear 416 rotate in the same direction and at the same angular velocity. Since the output planet gears 422 are the same unitary body as the input planet gears 416, as the input planet gears 416 are rotated by the input sun gear 412, both the input planet gear 416 section and output planet gears 422 section rotate. The output planet gears 422 propagate about the output sun gear 418. The output sun gear 418 is an idler gear.

The output ring gear 420 is engaged with the output planet gears 422. The output ring gear 420 is coupled to the sprocket 320. The output ring gear 420 rotates responsive to movement of the output planet gears 422 to turn the sprocket 320.

The output section 318 is rotated in the clockwise or counterclockwise direction by the input section 316. For example, each of the input planet gears 416 drives an associated output planet gear 422.

In one direction of operation, as the electric motor 304a rotates in the clockwise direction, the input sun gear 412 rotates in the clockwise direction. Since the input ring gear 414 is fixed in position within the housing 302, each input planet gear 416 in the set of input planet gears 416 rotate in the counterclockwise direction about their respective central axis. The input planet gears 416 traverse across the inner toothed surface of the input ring gear 414 in the clockwise direction. As the input planet gears 416 rotate in the counterclockwise direction, so also the output planet gears 422 rotates in the counterclockwise direction. Since the output ring gear 420 is free to rotate, it therefore rotates clockwise and likewise rotates the sprocket 320 clockwise. Clockwise rotation of the sprocket 320 across the rack 312 moves the lift drive 102 vertically in the downward direction 144, lowering the grabber arms 123 toward the surface of the Earth.

Similarly, in the other direction of operation, as the electric motor 304a rotates in the counterclockwise direction, the input sun gear 412 rotates in the counterclockwise direction. Since the input ring gear 414 is fixed in position within the housing 302, each input planet gear 416 in the set of input planet gears 416 rotates in the clockwise direction about their respective central axis. The input planet gears 416 traverse across the inner toothed surface of the input ring gear 414 in the counterclockwise direction. As the input planet gears 416 rotate in the clockwise direction, so to the output planet gears 422 rotate in the clockwise direction. Since the output ring gear 420 is free to rotate, it therefore rotates counterclockwise and likewise rotates the sprocket 320 counterclockwise. Counterclockwise rotation of the sprocket 320 across the rack 312 moves the lift drive 102 vertically in the upward direction 142, raising the grabber arms 123 away from the surface of the Earth.

In this implementation, the output sun gears 418 have an axial overlap with the sprocket 320. This arrangement can further reduce the overall axial length of the gearbox 306.

The output ring gears 420 are effectively locked together with the sprocket 320. In other embodiments, a single output sun gear 418 can be engaged by both sets of output planet gears 422 and offset circumferentially to take up even less axial space within the housing 302.

In this embodiment, the output section 318 is positioned inward from the sprocket 320. This arrangement can reduce the overall volume of the gearbox 306. In other implementations, the output ring gear 420 can be coupled to the sprocket 320 by a flange, a flange and hub assembly, a press fit, welded, or any suitable means of coupling.

In this embodiment, the output ring gears 420 are a separate component from the sprocket 320. The output ring gears 420 are coupled to the sprocket 320 by the pins 402. In other implementations, the output ring gears 420 can be integrally formed with the sprocket 320. For example, the output ring gears 420 and the sprocket 320 can be formed from a single unitary body or are fixed together to rotate in unison. The teeth 314 of the sprocket 320 extend outward from the body, and the teeth of the output ring gear 420 extend inward. The teeth 314 are a series of projections extending outward from the output ring gear 420 to vertically engage the rack 312 to reposition the grabbers 123 along the mast 126.

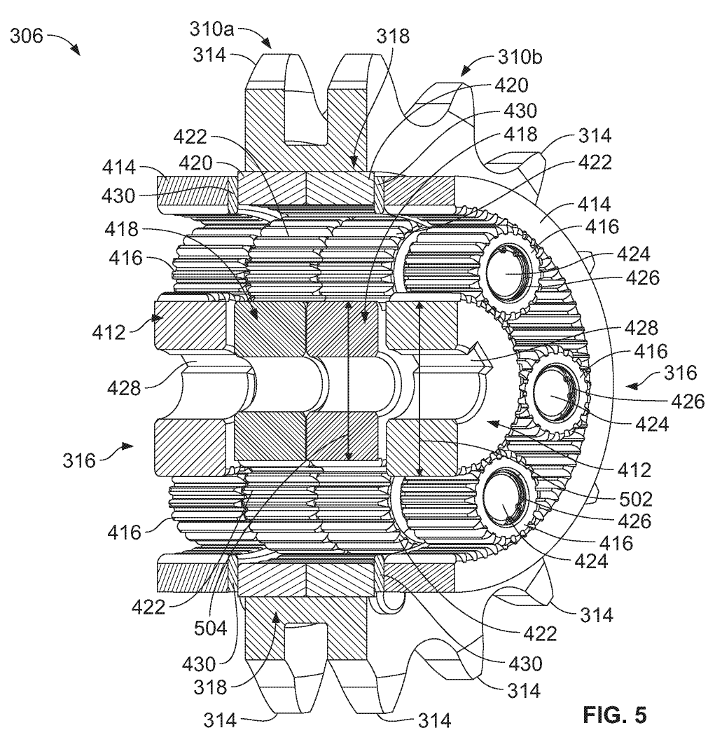

The diameters, numbers of teeth, size of teeth, shape of teeth, and spacing of teeth on each of the input sun gear 412, input planet gears 416, input ring gear 414, output sun gear 418, output ring gear 420, and output planet gears 422 are selected based on the desired gear ratio to move the lift drive 102 to raise or lower the customer refuse container. Referring to FIG. 5, the input sun gear 412 has a diameter 502 and the output sun gear 418 has a diameter 504. The diameter 502 of the input sun gear 412 is greater than the diameter 504 of the output sun gear 418. The input sun gear 412 has more teeth than the output sun gear 418.

FIG. 8 shows a side view of an input planet gear 416 and the associated output planet gear 422 mounted on one of the shafts 424. The input planet gear 416 has a diameter 802. The output planet gear 422 has a diameter 804. The diameter 802 of the input planet gear 416 is less than the diameter 804 of the output planet gear 422. The output planet gear 422 has more teeth than the input planet gear 416.

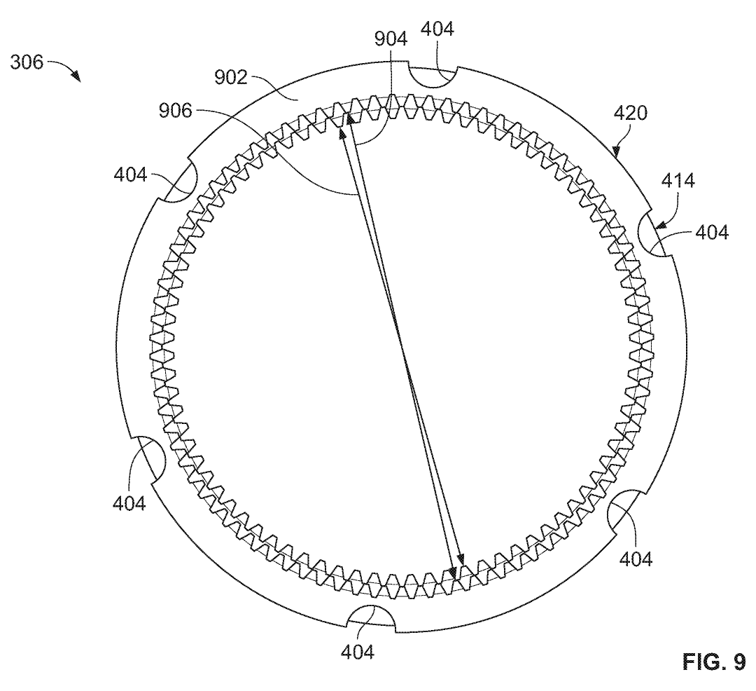

Referring to FIG. 9, an inward facing surface 902 of the output ring gear 420 is the forward most surface. The output ring gear 420 is positioned in front of the input ring gear 414. The output ring gear 420 has an inner diameter 904. The input ring gear 414 has an inner diameter 906. The inner diameter 906 of the input ring gear 414 is less than the inner diameter 904 of the output ring gear 420. The input ring gear 414 has fewer teeth than the output ring gear 420.

The gear ratio for a compound split ring planetary gear ratio is the number of teeth in the output ring gear 420 compared to the input ring gear 414. In this implementation, the gear ratio of the compound split ring planetary gear assemblies 308a, 308b is approximately 25.5. However, in other implementation, any suitable gear ratio may be used.

The number of teeth for each component of the compound split ring planetary gear assemblies 308a, 308b can be selected based on the desired gear ratio and each application. Additionally, the number of input planet gears 416 and output planet gears 422 is likewise selected based on the application. In this implementation, the input sun gear 412 has thirty-six teeth, the input planet gear 416 has twenty teeth, the input ring gear 414 has eighty teeth, the output planet gear 422 has twenty-four teeth, the output sun gear 418 has forty teeth, and the output ring gear 420 has eighty-four teeth.

Determination of the specific quantity of teeth and input planet gears 416 and output planet gears 422 can be based on a mechanical analysis of each application. One major driving factor in deciding the applicable gear ratio is the differential quantity of teeth between the output ring gear 420 compared to the input ring gear 414. Selection of the appropriate number of teeth for the output ring gear 420 compared to the input ring gear 414 can be determined based on the gear module, the overall diameters, and the desired gear ratio.

The planet and sun gear teeth quantity and design can be based on the number of teeth required to properly mesh with the output ring gear 420 and the input ring gear 414 while also ensuring that the planet gears on in both the input section 316 and the output section 318 are concentrically aligned. Concentric alignment the input section 316 and the output section 318 can be made easier with a centrally mounted carrier plate 430 between the input section 316 and the output section 318. Further, tooth stress can impact the number and design of teeth. For example, a smaller number of teeth can increase individual tooth stress and reduces overall lifespan of the associated component.

In other implementations, one or more compound split ring planetary gear assemblies 308a, 308a can be oriented horizontally or at an angle relative to the refuse collection vehicle 100. For example, when the compound split ring planetary gear assemblies 308a, 308a are oriented horizontally or angled, the compound split ring planetary gear assemblies 308a, 308a can move the grabber arms 123 to travel in the horizontal direction 114, 116 or in the transverse direction 117.

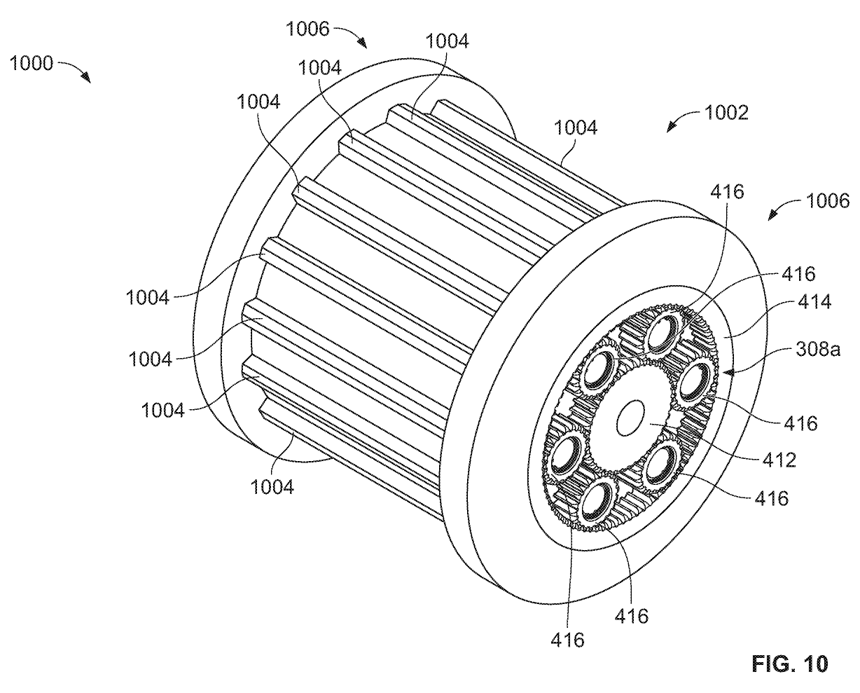

Referring to FIG. 10, a pulley lift drive 1000 is used for repositioning the grabber 128 along the mast 126 of the refuse collection vehicle 100. In this embodiment, the mast 126 includes a fixed chain loop and the pulley lift drive 1000 includes a housing with a drum 1002. The drum 1002 has projections 1004 extending from the drum 1002. The projections 1004 engage the fixed chain loop. The pulley lift drive 1000 has one or more compound split ring planetary gear assemblies 308a, 308b coupled to opposite sides 1006 of the drum 1002 to rotate the drum 1002 in the clockwise or counterclockwise direction to vertically raise or lower the grabber 128. In other implantations, the mast 126 can include a gear belt and the projections 1004 engage the gear belt to raise or lower the grabber 128. In one embodiment, as shown in FIG. 10, the compound split ring planetary gear assemblies 308a, 308b, including both of the input ring gears 414 are positioned entirely or nearly entirely within the drum 1002 but still fixed so as to not rotate. The shaft of the electric motors 304a, 304b extend into the drum 1002. In another embodiment, the input ring gear 414 can extend partially or entirely extend outside the drum 1002 to couple with the housing 302.

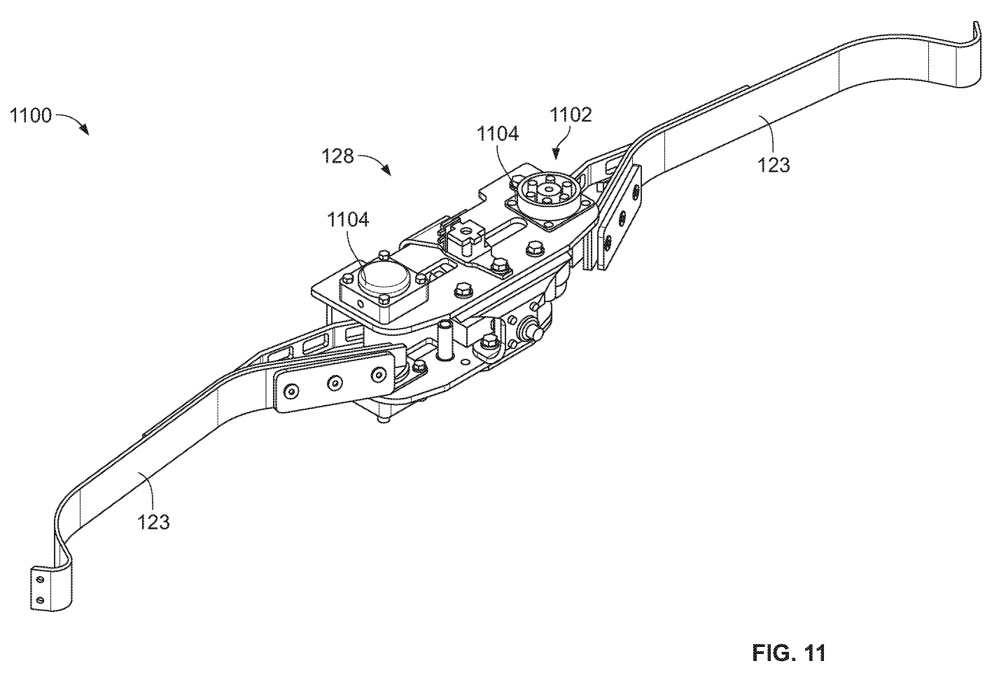

Referring to FIG. 11, a grabber assembly 1100 includes the grabber 128 and one compound split ring planetary gear assembly 1102 to open and close the grabber arms 123. The grabber assembly 1100 has an electric motor, not shown, coupled to the one compound split ring planetary gear assembly 1102 to rotate the 1102 in the clockwise or clockwise direction to open and close the grabber arms 123. The one compound split ring planetary gear assembly 1102 is substantially similar to the compound split ring planetary gear assemblies 308a, 308b previously described.

The grabber arms 123 are each rotatable about a respective pivot bearing assembly 1104. The grabber arms 123 are mechanically linked to one another by one or more gears or linkages.

The output ring gear of the one compound split ring planetary gear assembly 1102 is engaged to one of the grabber arms 123. As the electric motor rotates, the output ring gear rotates in the same direction, articulating both of the attached grabber arms 123 between an open position and a closed position.

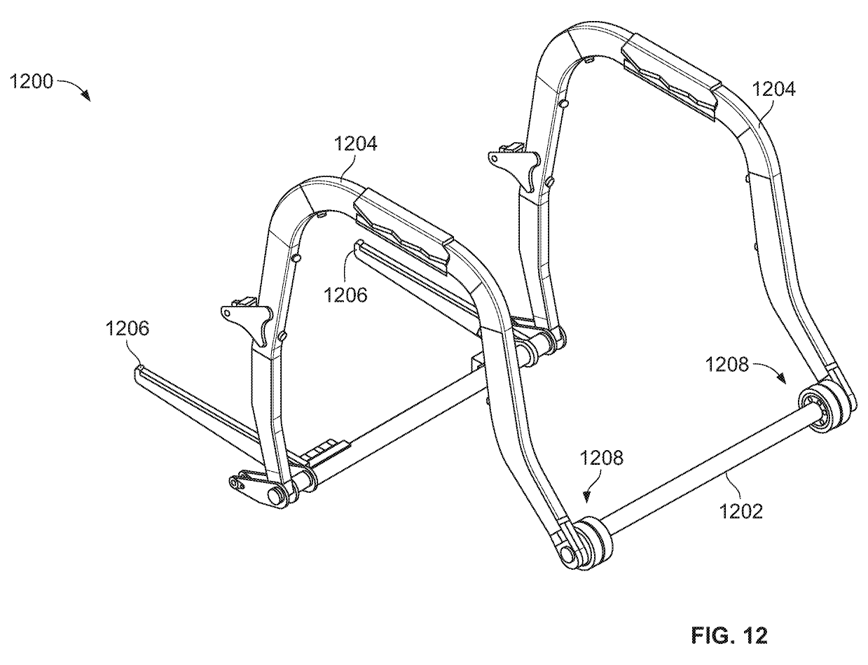

Referring to FIG. 12, a front-end loader 1200 can be mounted on the refuse collection vehicle 100 to engage and lift customer refuse containers from the front of the refuse collection vehicle 100. The front-end loader 1200 is rotatably mounted to the front end of the refuse collection refuse collection vehicle 100.

The front-end loader 1200 has a shaft 1202 fixed to the chassis 106, a frame 1204 rotatable about the shaft 1202, and forks 1206 extending from the frame 1204 to engage the customer refuse container. The front-end loader 1200 has one or more compound split ring planetary gear assemblies 1208. The one or more compound split ring planetary gear assemblies 1208 are mounted between the shaft 1202 and the frame 1204. The input sections of the compound split ring planetary gear assemblies 1208 are fixed in position to the shaft 1202. The input sun gear is keyed to the shaft 1202. The output sections of the compound split ring planetary gear assemblies 1208 coupled to the frame 1204. The front-end loader 1200 includes a bracket between the input ring gear and the output ring gear that is fixed.

Referring to FIGS. 1-2, the packer 130 is a rotatable packer. The packer 130 rotates about a shaft to move the customer refuse that has been deposited in the hopper 118 backwards 116 into the storage container 120. The refuse collection vehicle 100 includes an electric motor 146 and a compound split ring planetary gearbox 148 to rotate the packer 130. The electrical motor 146 is coupled the compound split ring planetary gearbox 148 and rotates the compound split ring planetary gearbox 148 in the clockwise or counterclockwise direction to move customer refuse through the hopper 118. The compound split ring planetary gearbox 148 is substantially similar to the compound split ring planetary gear assemblies 308a, 308b previously described.

In other embodiments, the packer 130 has a rearward refuse facing surface that translates forward 114 and backward 116 through the hopper 118 to reposition the deposited customer refuse. The refuse collection vehicle 100 can include a horizontally oriented rack, similar to the rack 312, and an electric motor with a compound split ring planetary gearbox similarly coupled between the electric motor and the rack to horizontally move the rearward refuse facing surface in the forward 114 and backward 116 directions to reposition the customer refuse within the refuse collecting body 108.

In another embodiment, a twin motor drive has two drive motors and a dual input compound split ring planetary gear assembly. The compound split ring planetary gear assemblies 308a, 308b can be arranged in the dual input configuration. The dual input compound split ring planetary gear assembly is disposed between and connected to the two drive motors. For example, the drive motors can be the electric motors 304a, 304b, hydraulic motors, or any other suitable motive source. The dual input compound split ring planetary gear assembly has a first planetary geartrain, a second planetary gear train, and a third planetary gear train connecting the first planetary geartrain to the second planetary gear train. For example, the dual input compound split ring planetary gear assembly can be the gearbox 306 including the compound split ring planetary gear assemblies 308a, 308b with the first electric motor 304a coupled to and driving the first input sun gear 412 in the first compound split ring planetary gear assembly 308a and the second electric motor 304b coupled to and driving the second input sun gear 412 in the second compound split ring planetary gear assembly 308b.

The third planetary geartrain connects the first and second planetary geartrains by using planet gears that are fixed to rotate with associated planet gears of both the first and second planetary geartrains. For example, in one implementation, one output planet gear 422 is integrally formed in a single unitary body with one of the input planet gears 416. In another implementations, two sets of a single unitary body having one input planet gears 416 and one output planet gear 422 are coupled together on the shaft 424. The third planetary geartrain includes the output ring gear 420. The first sun gear 412 to the output ring gear 420 forms a drivetrain for the first electric motor 304a. The second sun gear 412 to the output ring gear 420 forms another drivetrain for the second electric motor 304b. The two electric motors 304a, 304b may be simultaneously operated to cooperatively drive one or more output ring gears 420.

In some implementations of the twin motor drive, the drivetrain for the first of the two drive motors and the drivetrain for the second of the two drive motors define numerically identical gear ratios. For example, the compound split ring planetary gear assemblies 308a, 308b can have the same gear ratios. In other implementations, the gearbox 306 can have a clutch mechanism between the output ring gears 420 which is operable to engage or disengage the opposing output ring gears 420 to the sprocket 320. In other implementations, the gearbox 306 can include another clutch to move one or both of the 310a, 310b into and out of contact with the roller chain.

In some implementations of the twin motor drive, the two drive motors each have a rotor, and wherein the rotors of the two drive motors are colinear. For example, a longitudinal axis of the shaft of the rotors of the electric motors 304a, 304b are colinear.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

1. A refuse collection vehicle, comprising:
a vehicle chassis; and
a refuse body physically mounted on the vehicle chassis, the refuse body comprising:
a lift assembly comprising:
a mast;
a grabber; and
a lift drive coupling the grabber to the mast, the lift drive configured to vertically reposition the grabber along the mast and comprising:
an electric motor; and
a gearbox configured to be driven by the electric motor;
wherein the gearbox comprises a compound split ring planetary gear assembly comprising an input sun gear connected to the electric motor and an output ring gear rotatable to move the grabber along the mast.

2. The refuse collection vehicle of claim 1, wherein the mast comprises a rack and the lift drive comprises a sprocket engaged to the rack, the compound split ring planetary gear assembly driving the sprocket to vertically reposition the lift drive along the rack relative to the mast.

3. The refuse collection vehicle of claim 2, wherein the compound split ring planetary gear assembly further comprises:
an input section comprising:
a first input ring gear fixed in position within a housing of the lift drive;
the input sun gear is a first input sun gear driven by the electric motor; and
a first set of input planet gears coupling the first input sun gear to the first input ring gear; and
an output section comprising:
the output ring gear is a first output ring gear, the first output ring gear coupled to the sprocket, the first output ring gear rotatable relative to the first input ring gear;
a first set of output planet gears coupled to and extending from the first set of input planet gears, the first set of output planet gears coupled to the first output ring gear, the first set of output planet gears driving the first output ring gear; and
a first output sun gear positioned inward from the first set of output planet gears.

4. The refuse collection vehicle of claim 3, wherein the first output sun gear is an idler.

5. The refuse collection vehicle of claim 3, wherein rotation of the electric motor rotates the first input sun gear, the first input sun gear rotates the first set of input planet gears around the first input ring gear moving the first set of output planet gears about the first output sun gear, and responsive to moving the first set of output planet gears, rotating the first output ring gear relative to the first input ring gear.

6. The refuse collection vehicle of claim 3, wherein the first input sun gear is defined by a first input sun gear diameter and the first output sun gear is defined by a first output sun gear diameter, the first input sun gear diameter greater than the first output sun gear diameter.

7. The refuse collection vehicle of claim 3, wherein the first set of input planet gears are each defined by a first input planet gear diameter and the first set of output planet gears are each defined by a first output planet gear diameter, the first input planet gear diameter less than the first output planet gear diameter.

8. The refuse collection vehicle of claim 3, wherein a gear ratio between the first input ring gear and the first output ring gear is approximately 25.5.

9. The refuse collection vehicle of claim 3, further comprising a set of shafts, each shaft of the set of shafts coupling an associated input planet gears of the first set of input planet gears to an associated output planet gear of the first set of output planet gears.

10. The refuse collection vehicle of claim 2, wherein the electric motor is a first electric motor, the compound split ring planetary gear assembly is a first compound split ring planetary gear assembly, and the sprocket is a first sprocket, the lift drive further comprises:
a second electric motor; and
a second compound split ring planetary gear assembly coupled between the second electric motor and the mast, a second output ring gear of the second compound split ring planetary gear assembly coupled to a second sprocket engaged to the rack.

11. The refuse collection vehicle of claim 10, wherein the first sprocket and the second sprocket are fixed together to rotate in unison.

12. The refuse collection vehicle of claim 2, wherein the sprocket comprises the output ring gear.

13. The refuse collection vehicle of claim 2, wherein teeth of the output ring gear extend inward from the output ring gear and teeth of the sprocket extend outward from an outer surface of the output ring gear.

14. The refuse collection vehicle of claim 2, further comprising a flanged hub coupling the output ring gear to the sprocket.

15. The refuse collection vehicle of claim 1, wherein the output ring gear comprises a series of projections extending outward from the output ring gear to vertically reposition the grabber along the mast.

16. The refuse collection vehicle of claim 1, wherein:
the mast comprises a chain; and
a drum comprising a series of projections extending outward from the drum to engage the chain, the drum driven by the compound split ring planetary gear assembly to vertically reposition the grabber along the mast.

17. The refuse collection vehicle of claim 1, further comprising:
wherein the grabber comprises:
grabber arms;
a second electric motor; and
a second gearbox coupling the second electric motor to the grabber arms, the second gearbox comprising a second compound split ring planetary gear assembly comprising:
a second input sun gear connected and driven by the second electric motor; and
a second output ring gear rotatable to articulate the grabber arms between an open position and a closed position to engage a customer refuse container.

18. A refuse collection vehicle, comprising:
a vehicle chassis;
a refuse body physically mounted on the vehicle chassis;
a packer configured to reposition customer refuse within the refuse body; and
a drive assembly configured to operate the packer, the drive assembly comprising:
an electric motor; and
a gearbox coupling the electric motor to the packer, the gearbox comprising a compound split ring planetary gear assembly comprising:
an input sun gear connected and driven by the electric motor; and
an output ring gear rotatable to operate the packer to reposition customer refuse within the refuse body.

19. The refuse collection vehicle of claim 18, wherein the output ring gear is rotatable to rotate the packer to reposition customer refuse within the refuse body.

20. The refuse collection vehicle of claim 18, wherein the output ring gear is rotatable to translate a position of the packer within the refuse body to reposition customer refuse within the refuse body.
